(19) United States
(12) Patent Application Publication
(10) Pub. No.: US 2002/0124470 A1
(43) Pub. Date: Sep. 12, 2002

(54) Exterior door with overlays

(76) Inventors: Bryan P. Zacher, Brookings, SD (US); Allen E. Lee, Brookings, SD (US)

Correspondence Address: ROCKEY, MILNAMOW & KATZ, LTD., Two Prudential Plaza, Suite 4700, 180 North Stetson Avenue, Cicago, IL, 60601, US

(21) Appl. No.: 09/804,384

(22) Filed: Mar. 12, 2001

(51) Int. Cl. E05D 7/00

(52) U.S. Cl. 49/400

(57) ABSTRACT

An exterior door incorporates first and second overlays which extend laterally from the sides of the door so as to cover spaces between the door and the respective sides of the door frame. A third overlay can be attached to and extend across the top of the door, perpendicular to the overlays which extend along the sides of the door to cover the space between the top of the frame and the top of the door. The overlays frame, in part, the exterior surface of the door.

### FIELD OF THE INVENTION

The invention pertains to exterior doors. More particularly, the invention pertains to improved exterior doors which cover spaces between the door and an adjacent frame.

### BACKGROUND OF THE INVENTION

Storm doors are often used in addition to a solid security door promote the comfort and enjoyment of a residence. In summer, such doors can be provided with a screen to facilitate the circulation of exterior air in and out of the residence. In winter, such doors can be provided with glass and thereby create a trapped volume of air between the doors for additional insulation. Additionally, when fitted with glass, storm doors make it possible to have an interior door open for an extended period of time without admitting cold exterior air into the residence.

Some forms of known storm doors are formed primarily of aluminum. Others incorporate a non-metallic core covered with aluminum sheet. Representative types of cores include particle board, plywood, solid wood and similar types of filler material.

Solid core doors provide improved insulation over aluminum doors. They also provide the advantage of a heavier more substantial door structure.

Such doors are usually hingedly supported in a frame which is in turn attached to a door opening in the residence. The frame usually has two spaced apart parallel sides and a top which connects the two sides. The frame defines a three sided door receiving region. The door is able to swing away from and into the frame on hinges. The door can be opened, rotated out of the frame, for ingress to and egress from the residence. Additionally, the door can be closed, rotated into the frame, and locked for security purposes.

To enable the door to rotate in and out of the door receiving region bounded by the frame, there must be enough space between the non-hinged rotating edge of the door and the adjacent side of the frame to allow the width of the door to rotate into the closed position in the frame. This space will be susceptible to both hot and cold breezes blowing against the door.

One known solution to sealing the space between the door and the frame is to use weatherstripping carried on the door, the frame or both. While effective for minimizing the flow of unwanted air through the space between the door and the frame, weatherstripping tends not to be a complete solution. As the weatherstripping ages, it loses some of its ability to block the inflow of exterior air.

It would be desirable to be able to block the inflow of exterior air through the spaces between the door and the frame with an exterior barrier. Preferably such a barrier could be not only cost effectively incorporated into the door but would also contribute to the overall appearance of the door both when the door is closed and when it is open. Additionally, it would be preferable if the barrier could be manufactured inexpensively and could be used on a variety of different doors.

### SUMMARY OF THE INVENTION

An exterior door is rotatably carried in a frame. Spaces between the door and the frame enable the door to be rotated into and out of an internal region defined by the frame. The door can have a non-metallic core. Door cores can include one or more of foam, solid wood, wood composites, paper, plastic or, honeycombed paper, plastic or wood.

An overlay, or overlap, is attached to at least one edge of the door. The overlap, which could be molded or extruded plastic or metal, has a first curved section that curves away from the edge of the door, and, a second curved section which curves toward the frame.

The second curved section of the overlay extends, at least in part, over the adjacent space between the door and the frame. The overlay permits rotation of the door from the frame in a first direction; and opposite the first direction to the internal region. The overlay blocks continued rotation of the door in the first direction past the internal region.

In one embodiment, the door can carry first and second substantially identical, parallel overlays on spaced apart edges of the door. The door is rotatably attached to the frame by at least one hinge.

In one aspect, the frame is U-shaped with two elongated sides that extend parallel to and along the edges of the door with a space therebetween to permit rotation of the door. The sides are fixedly spaced apart from one another by an upper member that extends therebetween. The two sides and the upper member define a three-sided internal region.

The overlays may cover the hinges and the spaces between the door and the frame, at least in part. The presence of the overlays also reduces the ingress of external breezes into the spaces between the door and the frame.

In an embodiment, the overlays are formed of molded or extruded plastic, such as vinyl, or metal extrusions. Each extrusion has a door attachment section as well as a first section that curves away from the door and a second section that curves back toward the adjacent side of the frame.

In one embodiment, the attachment section is L-shaped. In another embodiment, the attachment section is U-shaped.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a front elevational view of a door/frame assembly in accordance with the present invention;

FIG. 2A is an enlarged fragmentary view of a part of the door/frame assembly of FIG. 1;

FIG. 2B is an enlarged partial fragmentary view of another part of the door frame assembly of FIG. 1;

FIG. 3 is a sectional view taken along plane 3-3 of FIG. 1;

FIG. 4 is a sectional view taken along plane 4-4 of FIG. 1;

FIG. 5A is a top plan view of the overlay of FIG. 3 usable with the door/frame assembly of FIG. 1;

FIG. 5B is another top plan view, illustrating additional details of the overlay of FIG. 5A;

FIG. 6 is a fragmentary perspective view of the overlay of FIG. 5A mounted on a door as in FIG. 1;

FIG. 7A is atop plan view of another overlay usable with the door/frame assembly of FIG. 1;

FIG. 7B is another top plan view illustrating additional details of the overlay of FIG. 7A; and

FIG. 8 is a fragmentary perspective view of the overlay of FIG. 7A mounted on a door as in FIG. 1.

### DETAILED DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

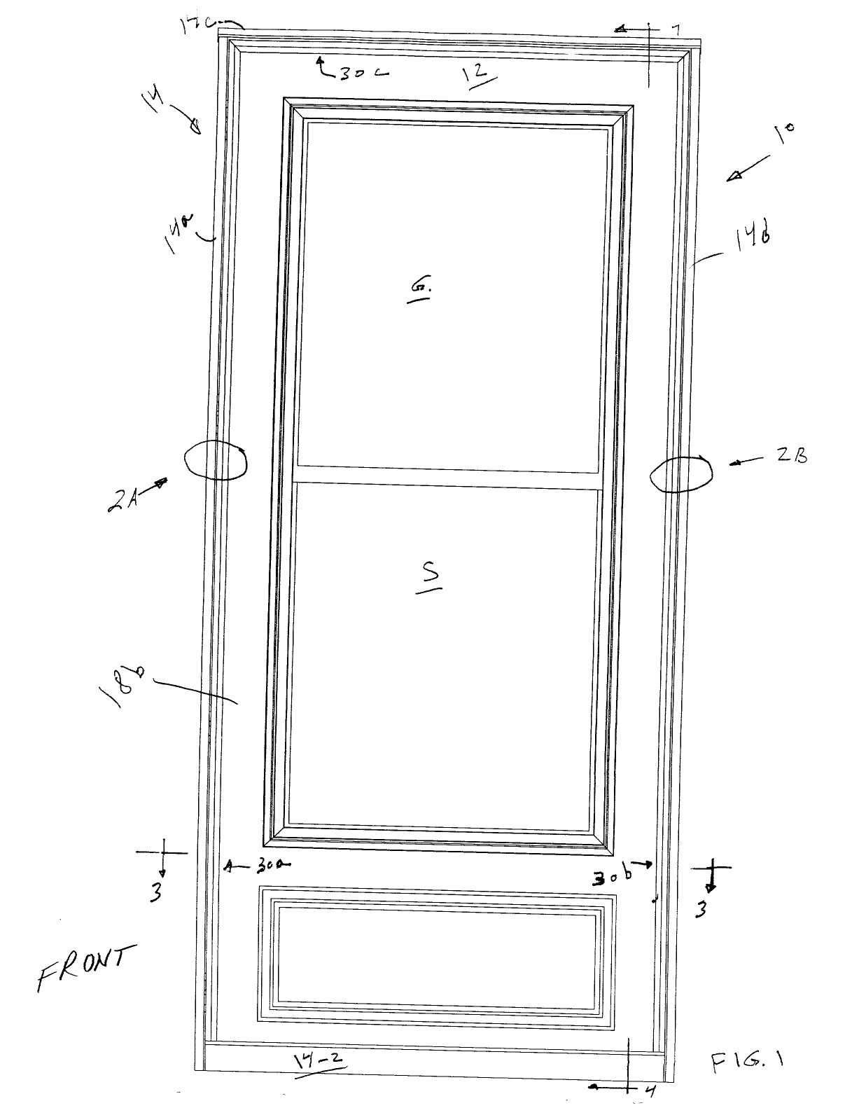

FIG. 1 illustrates a door/frame assembly 10 which carries wind blocking overlays in accordance with the present invention. The assembly 10 has an elongated rectangular door 12. Door 12 could be a storm door which incorporates one or more glass panels indicated generally at G. The door 12 could also incorporate one or more screen panels indicated generally at S.

Door 12 is rotatably mounted in a frame generally indicated at 14. Frame 14 is preferably formed of metal such as aluminum although use of a wooden frame would not depart from the spirit and scope of the present invention.

Frame 14 incorporates two elongated substantially parallel, spaced apart sides 14a, b and a perpendicular upper section 14c which joins the sides 14a, b. Taken together, the sections 14a, b and c bound a door receiving region R on three sides. The door 12 can be rotated from a closed position, indicated in FIG. 1, to an open position with one end extending away from the frame to permit ingress and egress from the residence.

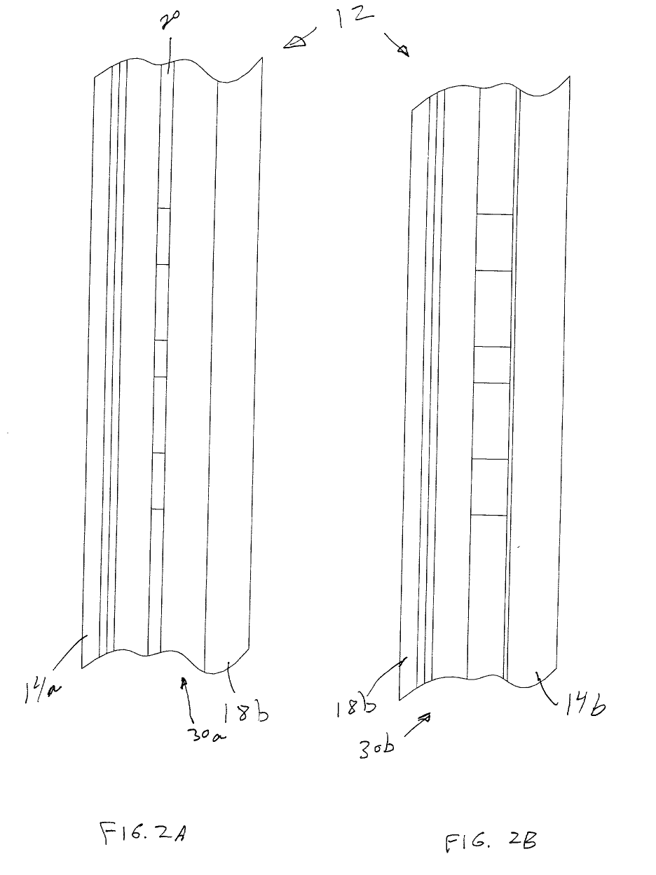

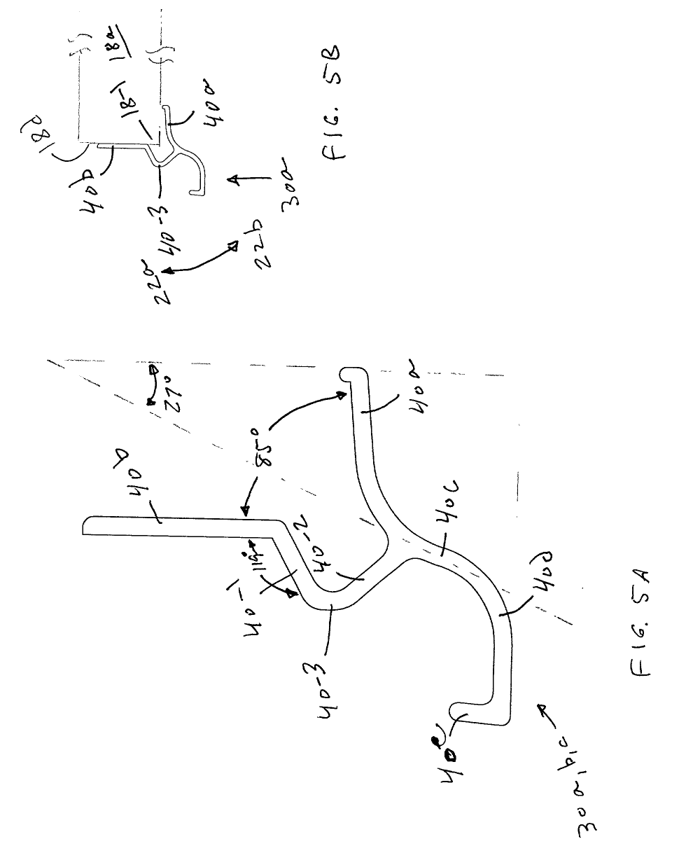

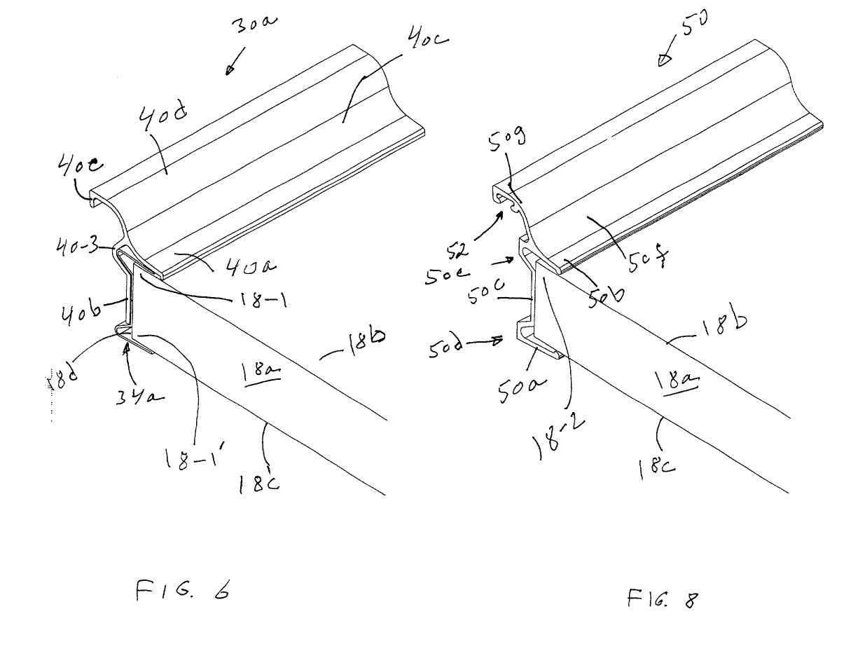

FIGS. 2A, 2B, 3-4 illustrate additional details of the assembly 10. FIGS. 5A, B and 6 illustrate additional details of an overlay usable with the door 10.

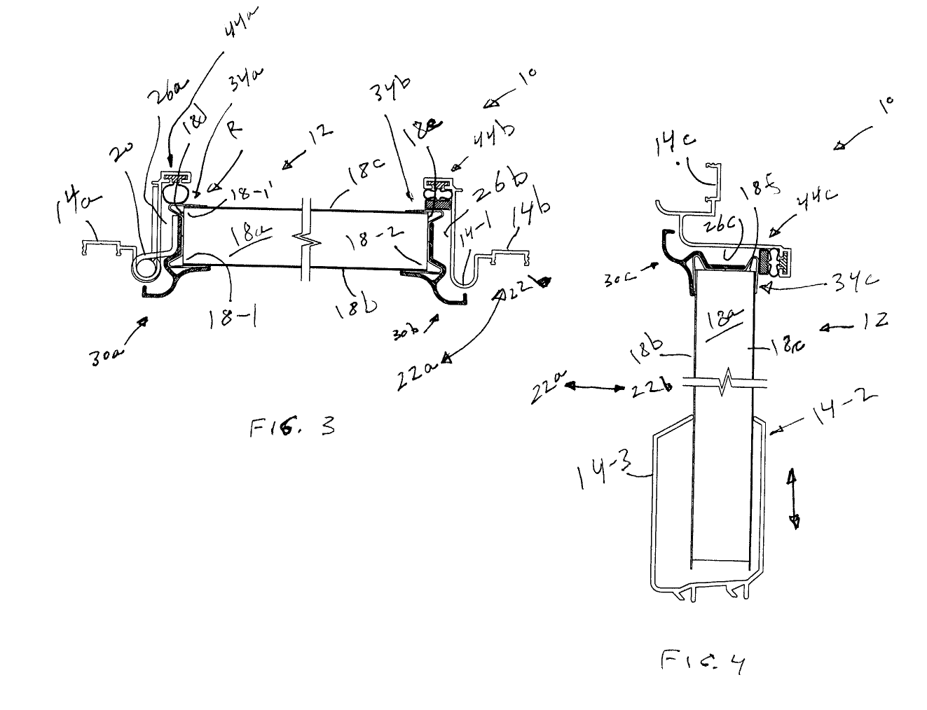

The door 12 includes a core 18a, best seen in FIGS. 3 and 4, which is generally elongated and rectangular in accordance with the space provided by the frame 14. Core 18a is covered in an illustrated embodiment by metallic sheets 18b, 18c. As will be understood by those of skill in the art, the sheets 18b and 18c could be formed of aluminum which has been treated, such as being anodized or painted to exhibit different colors.

The door 12 is rotatably attached to the frame 14 by a hinge 20, best seen in FIGS. 2A and 3. Hinge 20 permits door 12 to be rotated in a first direction, see FIG. 3, 22a away from frame 14 to an open state and in a second direction 22b back toward and into the frame 14.

As illustrated in FIG. 3, spaces 26a and 26b exist between adjacent portions of sides 14a and 14b of the frame and the door 12. Similarly, there is a space 26c, see FIG. 4, between door 12 and the top 14c of the frame. The spaces 26a, b and c facilitate rotary movement of the door 12 into and out of the door receiving region R formed by the three sides of the frame 14.

To block an inflow of exterior air through the spaces 26a, b, c as well as to optically cover those spaces, the door 12 carries first, second and third elongated, substantially identical overlays generally indicated at 30a, 30b and 30c. Overlays 30a and 30b extend parallel to one another along sides 18d and 18e of core 18a. Overlay 30c extends perpendicular to the overlays 30a, 30b along an upper or top edge 18f of core 18a.

Each of the overlays 30a, b, c could be attached directly to core 18a. Alternately, core 18a can be reinforced, best illustrated in FIGS. 3 and 4, by metallic reinforcing members such as the members 34a, 34b and 34c.

Each of the members 34a, 34b, 34c has a generally M-shaped cross section and could be formed of sheet steel. The reinforcing members 34a, 34b, 34c can be positioned between the respective overlays and the core 18a.

The assembly of the respective overlay, reinforcing member and core can be fastened together using screws or other types of fasteners as would be understood by those of skill in the art. It will also be understood that while the reinforcing members are illustrated in FIGS. 3 and 4 as having a generally M-shaped cross section, they in fact could be formed with just an L-shaped cross section without departing from the spirit and scope of the present invention. In such an embodiment, the L-shaped reinforcing element would underlie the attachment sections of the respective overlay, discussed subsequently.

FIG. 5A illustrates details of each of the overlays 30a, 30b, c. Each respective overlay includes first and second core abutting elements 40a and 40b each of which is elongated and is intended to abut either a portion of a reinforcing element, such as the element 34a or respective surfaces 18b and 18d in the absence of reinforcing element 34a.

Arcuately attached to element 40a is an element or extension section 40c which is curves or extends away from a corner 18-1 of core 18a, see FIG. 3. A second elongated section 40d arcuately extends back toward core 18a and an adjacent region of the respective frame member.

The second section 40d terminates in an end section 40e which is generally perpendicular to the section 40d. The end section 40e can be formed, if desired, at a 5° angle relatively to a line parallel to the element 40b. Elements 40b and 40c are joined by elements 40-1 and 40-2 which intersect in a region 40-3 displaced from the respective corner such as the corner, such as the corner 18-1 of the core 18a.

Thus, when the door 12 is closed against the frame 14, sections 40d of the respective overlay 30a, b, c extend over and cover the adjacent spaces between the door 12 and the frame 14 to improve the insulation characteristics thereof and also to hide the spaces between the door and the frame. As is illustrated in FIG. 3, the door 12 can rotate in the direction 22a away from the frame and in the direction 22b into the region R provided by the frame 14. The door 12 cannot rotate through the frame 14 at least for the reason that the section 40d of the overlay 30b extends horizontally, laterally, from the side of the door 12 effectively widening the door 12 such that section 14-1 of side 14b of the frame 14 blocks further movement of door 12 past the normally closed position. Similarly, section 40d of overlay 30c extends vertically, axially, from the top of the door 12 lengthening door 12 such that section 14-2 of the frame 14 blocks further movement of door 12 past the normally closed position.

It will be understood that the assembly 10 can incorporate weatherstripping and seals generally indicated at 44a, 44b and 44c if desired as would be understood by those of skill in the art without departing from the spirit and scope of the present invention. The presence or absence of additional insulating or weatherstripping material in the assembly 10 is not a limitation of the present invention.

For purposes of providing a height adjustment to the door 12, a slideably movable kick plate or threshold adjusting plate 14-2 can be mounted on a lower section of core 18a. The section 14-2 is movable vertically to adjust the height of the door 12 relative to the frame and the threshold.

The exemplary adjustment element 14-2 is formed with a laterally extending region 14-3 which in combination with the overlays 30a, b, c frames the exterior surface 18b of core 18a. This frame improves the appearance to the assembly 10 but is not a limitation of the present invention.

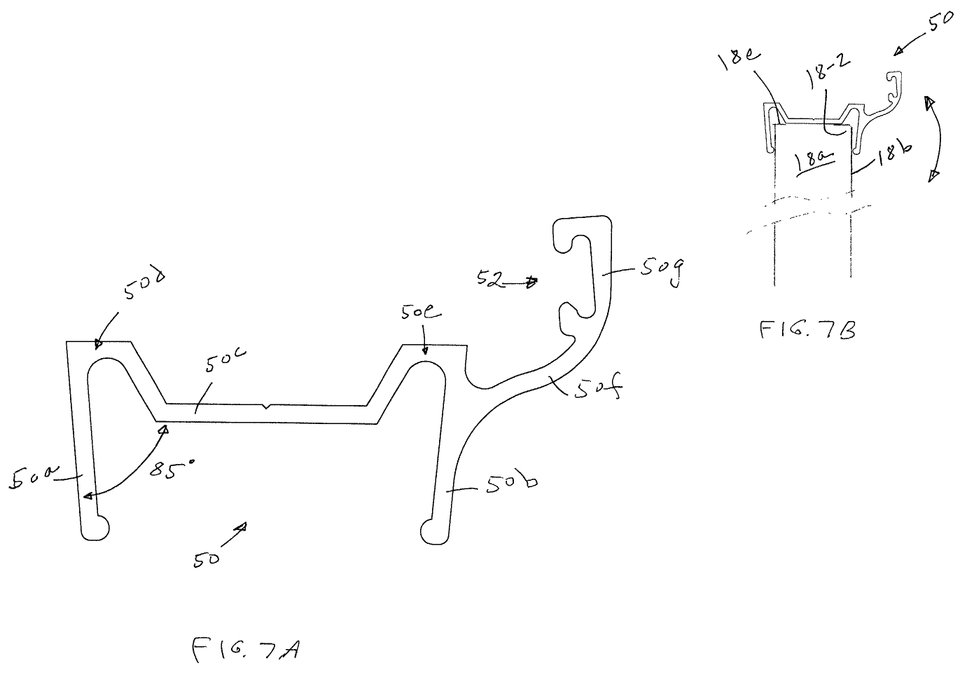

FIGS. 7A, 7B and 8 illustrate an alternate form of an overlay 50 which can be mounted on three sides of core 18a as discussed with respect to overlays 30a, 30b, 30c. The overlay 50 includes first and second spaced apart elements 50a and 50b which are generally linear and extend at an angle toward one another, as would be understood by those of skill in the art, so as to slideably engage surfaces 18b and 18c of core 18a, best seen in FIG. 7B. The elements 50a, 50b are joined by an elongated planar central section 50c. Elements 50a and 50c are oriented at an angle on the order of 85 degrees with respect to one another.

Elements 50a and 50c are jointed at a protrusion 50d. The elements 50b, 50c are joined at a protrusion 50e.

Protrusions 50d, 50e are provided so that a reinforcing member such as the members 34a, 34b or 34c can be slid onto the end of core 18a and the overlay 50 can in turn be positioned over the respective reinforcing element. The reinforcing element is then trapped between the overlay 50 and the end of the core 18a. If desired, common screws could be used to attach all three parts to one another to form a rigid assembly.

The overlay 50 includes a curved member 50f which curves away from a corner such as corner 18-2 of core 18a. The overlay 50 also includes a second member 50g which extends from the member 50f. Member 50g curves back toward the core 18a and respective frame elements such as frame element 14a, b, c. As discussed above, with respect to elements 40c and 40d the members 50f, 50g of overlay 50, when installed, cover the spaces between the door 12 and frame 14 thereby improving the insulating qualities of the assembly 10.

The overlays 30a, b, c and 50 can be formed as aluminum or plastic extrusions or moldings which can in turn be cut to length and assembled on the respective door 12. The overlay 50 can also carry a slotted region 52 which can be filled with weatherstripping as to further improve the insulating characteristics of the assembly 10.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A door comprising:
an elongated core with a selected width and a length and parallel, elongated sides;
at least one elongated overlay extending along an elongated side of the core wherein the overlay has a core mounting section and an arcuate extension section which extends away from the core in first region.

2. A door as in claim 1 wherein the extension section has a second region, which extends from the first region, wherein the second region curves toward the core.

3. A door in claim 2 wherein the second region terminates with a planar end region.

4. A door as in claim 1 wherein the core mounting section has a first perpendicular and the extension section has a second perpendicular wherein the perpendiculars are substantially parallel to one another.

5. A door as in claim 1 wherein the core mounting section has first and second arms wherein the arms are substantially perpendicular to one another.

6. A door as in claim 5 wherein the arms exhibit an L-shaped configuration.

7. A door as in claim 5 wherein the arms are joined at a protruding corner section.

8. A door as in claim 7 wherein the corner section extends from a corner of the core.

9. A door as in claim 8 wherein the corner section is displaced from the corner of the core.

10. A door as in claim 1 which includes a second elongated overlay, substantially identical to the one overlay, extending along another elongated side of the core wherein the edges extend parallel to one another.

11. A door as in claim 10 wherein the elongated sides are spaced apart by the core's width and wherein the overlays extend from the sides in a direction parallel to the core's width thereby forming an extended width greater than the core width.

12. A door as in claim 11, hingedly attached to a frame for rotation on an axis parallel to the elongated edges wherein the frame has an internal width for receiving the core but not the overlays therein.

13. A door as in claim 12 wherein the sides of the core are spaced from the frame to permit the core to rotate, at least in one direction, relative to the frame, and wherein the overlays cover the spaces, at least in part when the core is rotated into the frame.

14. A door as in claim 1 wherein the extension section has a second region, which extends from the first region, wherein the second region curves toward the core.

15. A door in claim 14 wherein the second region terminates with a planar end region.

16. A door as in claim 15 wherein the core mounting section has first and second arms wherein the arms are substantially perpendicular to one another.

17. A door as in claim 16 wherein the arms exhibit an L-shaped configuration.

18. A door as in claim 16 wherein the arms are joined at a protruding corner section.

19. A door as in claim 17 wherein the corner section extends from a corner of the core.

20. A door as in claim 19 wherein the corner section is displaced from the corner of the core.

21. A door as in claim 2 wherein the core includes a planer surface perpendicular to the edges and wherein the second region extends laterally from the respective side of the core and is displaced from the planar surface in a direction generally parallel to the side.

22. A door as in claim 21 which includes a second overlay extending along another side of the core wherein the first and second overlays are substantially identical, and wherein the second region of each extends from the planar surface thereby framing, at least in part, the surface therebetween.

23. A door as in claim 22 wherein the core is bounded by a third side, perpendicular to the first and second sides and which includes a third overlay extending along the third side, identical to and perpendicular to the first and second overlays wherein the three overlays frame the surface along three sides.

24. A door as in claim 22 wherein the core is rotatably attachable to a frame which defines a core receiving region wherein the overlays cover any spaces between the respective sides and the frame while the door is positioned in the core receiving region.

25. A door as in claim 22 wherein an elongated, reinforcing member, formed of one of plastic or metal, extends along the respective side of the core between the core and the respective overlay.

26. A door as in claim 25 wherein the reinforcing member exhibits an M-shaped cross section.

27. A door as in claim 26 wherein the reinforcing member has at least one region which is spaced from a corner formed by the respective side and the surface.

28. A door as in claim 27 wherein the reinforcing member has at least two regions which are spaced from the corner.

29. A door as in claim 28 wherein the respective overlay exhibits receiver spaces for respective regions of the reinforcing member.

30. A door as in claim 27 which carries at least one hinge attached to a side wherein the adjacent overlay covers the hinge at least in part.

31. A door as in claim 23 wherein the core is covered on first and second spaced apart, parallel surfaces, at least in part, with one of a metal sheet or a plastic sheet.

32. A door as in claim 31 wherein the core is formed of at least one of foam, wood, wood composite, paper composite, plastic or metal.

33. A door as in claim 32 wherein the overlays cover, in part, the core covering sheets and extend along and cover the respective side of the core.

34. A door as in claim 33 wherein the core mounting sections of the respective overlays are oriented at an angle in a range of about 80-90 degrees to one another.

35. A door as in claim 34 wherein the core mounting sections of the respective overlays are oriented at an angle of about 85 degrees to one another.

36. A door as in claim 34 wherein the respective arcuate extension sections of each overlay are oriented at an angle in a range of about 22-32 degrees to the sides of the core.

37. A door as in claim 36 wherein the respective arcuate extension sections of each overlay are oriented at an angle of about 27 degrees to the sides of the core.

38. A door as in claim 36 wherein the overlays are each formed of at least one of metal or plastic.

39. A door assembly comprising:
a frame which has two elongated parallel sides spaced apart by a section which is perpendicular thereto, wherein the frame defines a door receiving region bounded in part by the sides and the section;
a door, rotatably attached to the frame wherein the door is sized to be rotatable from the door receiving region to an angularly disposed location wherein when the door is in the door receiving region spaces exist between the sides of the frame and adjacent sides of the door; and
a first elongated overlay which is attached to one side of the door wherein the overlay has a multiple curved cross section wherein part of the overlay substantially covers the space between the respective side of the frame and the one side of the door.

40. An assembly as in claim 39 which includes a second elongated overlay, substantially identical to the first overlay, which is attached to a second side of the door wherein part of the second overlay substantially covers the space between the respective side of the frame and the second side of the door.

41. An assembly as in claim 39 wherein the frame and the overlay are metallic.

42. An assembly as in claim 3 9 wherein the door has a non-metallic core.

43. An assembly as in claim 42 wherein the core is covered, on a first surface perpendicular to the sides, with a layer formed at least in part of one of plastic or metal.

44. An assembly as in claim 43 wherein the layer faces a direction of rotation of the door away from the frame.

45. An assembly as in claim 44 wherein the overlay has a section which curves toward the direction of rotation of the door away from the frame.

46. An assembly as in claim 45 wherein the overlay has a second section which curves away from the direction of rotation of the door away from the frame.

47. An assembly as in claim 46 wherein the second section extends from the first section.

48. An assembly as in claim 47 wherein an end of the second section is positioned adjacent to the frame when the door is in the door receiving region.

49. An assembly as in claim 39 which includes a third elongated ovrlay attached to a third side of the door, substantially perpendicular to the first and second overlays and a closing member which slidably covers a fourth side of the core; and is parallel to the third overlay.
